(19) United States
(12) Patent Application Publication
(10) Pub. No.: US 2003/0066025 A1
(43) Pub. Date: Apr. 3, 2003

(54) Method and system for information retrieval

(76) Inventors: Harold R. Garner, Flower Mound, TX (US); Alexander Pertsemlidis, Coppell, TX (US)

Correspondence Address: GARDERE WYNNE SEWELL LLP, 3000 Thanksgiving Tower, 1601 Elm Street, Dallas, TX, 75201-4761, US

(21) Appl. No.: 10/196,738

(22) Filed: Jul. 15, 2002

Related U.S. Application Data
(60) Provisional application No. 60/305,212, filed on Jul. 13, 2001.

(51) Int. Cl. G06F 17/30

(52) U.S. Cl. 715/500

(57) ABSTRACT

The present invention is directed toward an improved method of mining data. The method uses a query composed of natural language text that may be expanded to include related terms and concepts. The query is parsed into a variety of textual elements that may be keywords, phrases, or concepts, and compared with one or more databases to determine what, if any, information units in the database are related to textual elements that have been culled from the query.

### PRIORITY CLAIM

This patent application claims priority to U.S. provisional patent application serial No. 60/305,212 filed on Jul. 13, 2001. The present application is timely filed under 35 C.F.R. §1.7(b) on Monday, Jul. 15, 2002 because the Jul. 13, 2002 fell on a Saturday.

### FIELD OF THE INVENTION

The present invention relates generally to the field of information processing, and specifically to a method and system for searching computer databases for information relevant to a specified reference or query.

### BACKGROUND OF THE INVENTION

Researchers, especially those in biomedicine, report their results in scientific manuscripts. Others then use that information to extend their own research. Because of the abundance of information available, (Medline currently has approximately 12,000,000 abstracts, and grows at a rate of ˜500,000/year), the efficient identification and retrieval of pertinent entries is essential for scientists to remain current even within a highly specialized and narrow area. The most common method for information retrieval is keyword-based queries, including those that allow Boolean operators. These queries frequently over- or under-specify the search parameters, resulting in too much, too little, or irrelevant returned data. The goal is to return an amount that is “just right”.

Accordingly, there is a need for a tool based on electronic text similarity finding, which can rapidly retrieve and sort entries from an indexed database that allows a user to submit text and then find similarity between that text and any other database of text that it is compared with.

### SUMMARY OF THE INVENTION

The present invention is directed toward an improved method of information processing. The method uses a query composed of natural language text that may be expanded to include related terms and concepts. The query is parsed into a variety of textual elements that may be keywords, phrases, or concepts, and compared with one or more databases to determine what, if any, information units in the database are related to textual elements that have been culled from the query.

One form of the present invention is a text comparison method for retrieving information from computer databases that includes the steps of extracting one or more textual elements from one or more queries for comparison with a target database and assigning a weighting factor to each textual element. The textual elements are then compared with the target database to identify a first group of selected information units.

The process may be modified at any point in the process and may be run iteratively. In an iterative implementation it is envisioned that a given set of information units obtained from a search in accordance with the present invention would form the basis of a subsequent query. The iterative process may be run for a finite number of cycles or until a desired level of convergence has been achieved.

Other features and advantages of the present invention will be apparent to those of ordinary skill in the art upon reference to the following detailed description taken in conjunction with the accompanying drawings.

### DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a flow chart illustrating an overall process in accordance with the present invention;

FIG. 2 is a flow chart illustrating one implementation of the present invention;

FIGS. 3A and 3B are flow charts illustrating the comparison process of FIG. 2;

FIG. 4 is a flow chart illustrating the check report file name process of FIGS. 3A and 3B;

FIG. 5 is a flow chart illustrating the read input file process of FIGS. 3A and 3B;

FIG. 6 is a flow chart illustrating the calculate total frequency process of FIG. 5;

FIG. 7 is a flow chart illustrating the text comparison process of FIGS. 3A and 3B;

FIG. 8 is a flow chart illustrating the create and insert article process of FIG. 7;

FIG. 9 is a flow chart illustrating the process readability process of FIG. 8;

FIG. 10 is a flow chart illustrating the insert article process of FIG. 8;

FIG. 11 is a flow chart illustrating the remove last article process of FIG. 10;

FIG. 12 is a flow chart illustrating the find word process of FIG. 7;

FIG. 13 is a flow chart illustrating the insert word or get word process of FIG. 5;

FIG. 14 is a flow chart illustrating the set word list process of FIG. 7;

FIGS. 15A and 15B are flow charts illustrating the write report process of FIGS. 3A and 3B;

FIG. 16 is a flow chart illustrating another implementation of the present invention with grammar induction;

FIG. 17 is a flow chart illustrating a grammar induction process of FIG. 16;

FIGS. 18A and 18B are screen shots illustrating one embodiment of the input/output screens used to obtain the parameters of FIG. 1 blocks 204 and 210; and

FIG. 19 is a screen shot of a three dimensional display of the search results in accordance with one embodiment of the present invention.

### DETAILED DESCRIPTION

While the making and using of various embodiments of the present invention are discussed herein in terms of a data mining application, it should be appreciated that the present invention provides many applicable inventive concepts that can be embodied in a wide variety of specific contexts. The specific embodiments discussed herein are merely illustrative of specific ways to make and use the invention and are not meant to limit the scope of the invention in any manner.

Biological and biomedical literature research deals with essentially three things; sequences, structures and abstracts. Tools for comparing sequences to each other currently exist. The tools that are capable of comparing base or residue sequences are widely used. There are also tools that compare one or more physical structures, however they are less well understood by the research community, and are thus used to a lesser degree. There are no real tools available for researchers to use to compare abstracts.

Databases are structured and are not uniformly populated, i.e., they have some distribution of entries inside them. Those distributions are not going to be the same from database to database. In order to make connections, to generate hypotheses, and in order to understand relationships better, it makes sense to look for what is resident in one database, and see how that maps onto the entries in another database. For example, one might start with a single entry from a sequence database, and use one of the comparison tools to see what other entries in the database are similar to it. This gives you a set of entries in a sequence database, and you can then map those onto their corresponding entries in a structure databases.

Since there are also comparison tools for structure databases, they may be used to see what other entries there are in the structure database that are related to the query, and those hits can in turn be mapped onto the sequence database, or a different kind of database altogether and thus continue the process. This system of hopping back and forth will fill in some of the gaps, and give a more complete picture of the domain of knowledge that is of interest.

An extension of this idea is to make the process iterative, with some control over how and when it is considered finished (or converged). This idea has seen some limited application already in sequence comparison applications that use the initial query to build up a profile by comparing it to entries in the database and abstracting common features from the results. The profile is then refined by following the same procedure for each of the returned results.

The implementation of the present invention supports multiple databases, iterative searches, similarity algorithms, results sorting, and automated re-searching. It also provides the infrastructure for expanded functionality such as grammar induction based searches, continuous introduction and linking of new databases, new user preferences, sub-document component retrieval, and is a pre-processor for other text based artificial intelligence tools for hypothesis generation, data analysis, etc.

Users (scientists, editors, students, lay people, lawyers, executives) compose their own text-based queries or submit extracts of text from other documents to find clusters of nearby documents. The present invention can accept queries for an immediate search or they can be saved for continuous monitoring and automatic notification of new “hits” found as the database expands. Examples of applications of the present invention include identification of publications to remain current in an area, to assist in review of article writing, reference list composition, idea novelty checking, proposal/manuscript reviewing, cross database comparisons, and hypothesis generation.

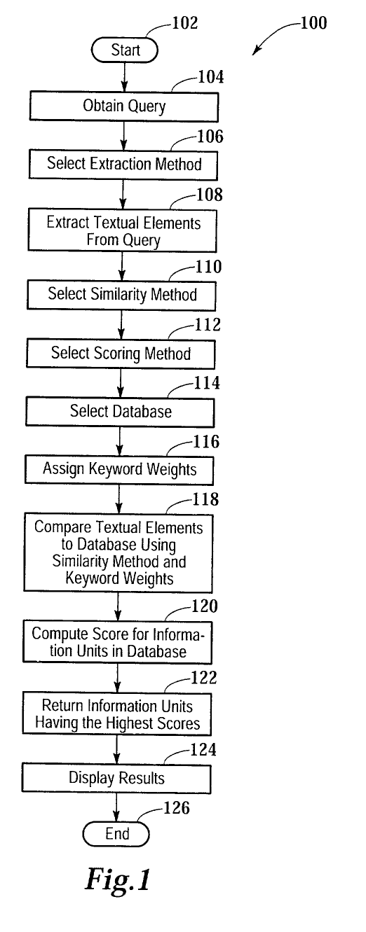

FIG. 1 is a flow chart illustrating an overall process 100 in accordance with the present invention. The overall process 100 starts in block 102 and one or more queries are obtained in block 104. An extraction method is selected in block 106 and is then used to extract one or more textual elements from the one or more queries in block 108. A similarity method is selected in block 110, a scoring method is selected in block 112, and a database is selected in block 114. Keyword weights may then be assigned in block 116. Thereafter, the textual elements are compared to the database using the selected similarity method and keyword weights in block 118. Scores are computed for the information units in the database 120 and the information units having the highest scores are returned in block 122. The results are displayed or provided to the user in block 124 and the process ends in block 126. All of these processes will be described in more detail below.

The subject matter of the present invention has been used to create a recomputed function FRISC (Faculty Research Interests Science Comparator). Every faculty member at the University of Texas Southwestern Medical Center has a written description of their research to be used to identify publications that correspond to their areas of interest. These form the basis of a query that is used to search Medline abstracts on a regular basis.

The database that has been implemented for searching is actually a subset of Medline, with about 400,000 abstracts from 2000 and 2001. The user input query is typically one or more paragraphs of text from which weighted keywords, concepts and the extensions (synonyms, lexical variants, etc.) are extracted. These form the basis of the search and ranking by similarity score.

These prose descriptions are much easier to generate, and provide a superior description of an individual faculty members interests than those generated in other ways. They provide a much better description than that provided by giving keywords or concepts. By extracting information from a text description, the inherent biases that occur when an individual attempts to create a list of keyword terms in an ad hoc fashion are eliminated.

The intent of the present invention is to assess the similarity between some set of text (it doesn't matter what language) and another (typically larger) database of text. The results contain the original submitted text, along with the selected results from the database and the keywords that were extracted from the original descriptive passage that was used as the basis for the query, and their associated weights.

Common words are eliminated because they are generally not useful in assessing similarity between data sets. Once the remaining keywords and the frequencies with which they occur in both the query document and the database are obtained, the sum of the products of the individual weights is calculated when the keyword appears in both documents. The results are then ranked by the total weight, normalized so that the length of the text does not have an effect. The results of the comparison are then generated. The final scores of individual results can be further adjusted to include factors such as the prestige or quality of the publication containing the “hit.”

There are also other types of queries that the present invention may be applied to such as text from an encyclopedia of molecular biology, or Harrison's Internal Medicine, or any other reference publication. This would provide a dynamic reference guide of clustered pertinent literature for a given topic such as peptic ulcers, small cell lung cancer, p450, or Huntington's chorea, to name but a few. Searches like this would provide links to the primary literature as well as providing excellent seeds (queries) for further iterative searches using the present invention.

One of the limitations of many existing search engines is that the analysis is strictly keyword-based, and the concepts such as “lung cancer” get split into the keywords “lung” and “cancer”. The present invention uses more sophisticated parsing, so that concepts, instead of keywords, are extracted. In addition, stemming is used so that the keyword “cancerous” will match not only against itself, but also against all words that are built on the same root. Similarly, the ability to handle synonyms may be incorporated, so that groups of terms, e.g. cancerous, tumor-causing, and oncogenic, can be generated by doing a synonym expansion of the query, and then comparing that against the database of keywords extracted.

A basic application of the present invention is to extract different pieces of information from a sample of text and relate their actual meaning. So, where one paper says something like “gene A regulates gene B”, and another paper says “gene B regulates gene C”, the program will be able to put together that information and generate a hypothesis. In this way the present invention may serve as a relational discovery tool that allows previously unappreciated relationships to be recognized and exploited.

Currently many search tools concentrate on performing a term frequency analysis, but the present invention also allows a concept count. One way this can be implemented is by a keyword distance matrix, which adjusts weights based on the separation of keywords in the text. For example, “lung” and “cancer” right next to each other most likely mean something different than “lung” and “cancer” in different sentences, and should probably be weighted differently. Additional features of the present invention include altering the weighting of particular terms manually. This can have many applications, but would be especially important in weighting terms that are very distinctive, but which are used infrequently.

It is also possible to resolve synonymous terms, i.e., where one investigator chooses to use one particular term and another investigator uses a different one. This can be handled by using lexical variant generation, where the keywords derived from the query text are mapped in a one to many mapping to some number of synonyms, each with the same weight as the original keyword. The comparison is then done using the expanded list, which should result in greater accuracy.

The present invention also allows for a number of different representations so the search results. There is the traditional listing of hits, but it is also possible to calculate the “distance” between the different search query results using the same term frequency analysis used to perform the basic searches. This results in a data set of the same dimension as the number of queries. Interestingly, most of the variance can be captured in three dimensions, and displayed in graphical form.

It is envisioned that the present invention will allow more than just finding lists of results from search queries. It will also allow those who use it to find relationships that they had not been aware of, and had not necessarily considered. Rather than merely going through a ranked list of results, the visual display allows the user to see the search results he is looking for as well as how the returned objects relate to each other.

The present invention is generally applicable, since it does not depend on any specific database. It can be applied in physics or law, or any field of interest. One use, of course, is to enable scientists to gather the most appropriate documents for a particular inquiry. Another is to review the current literature, for example, in the process of writing a review article. It may even be used in tracing the pedigree of a document, or to uncover the original sources in a case of plagiarism.

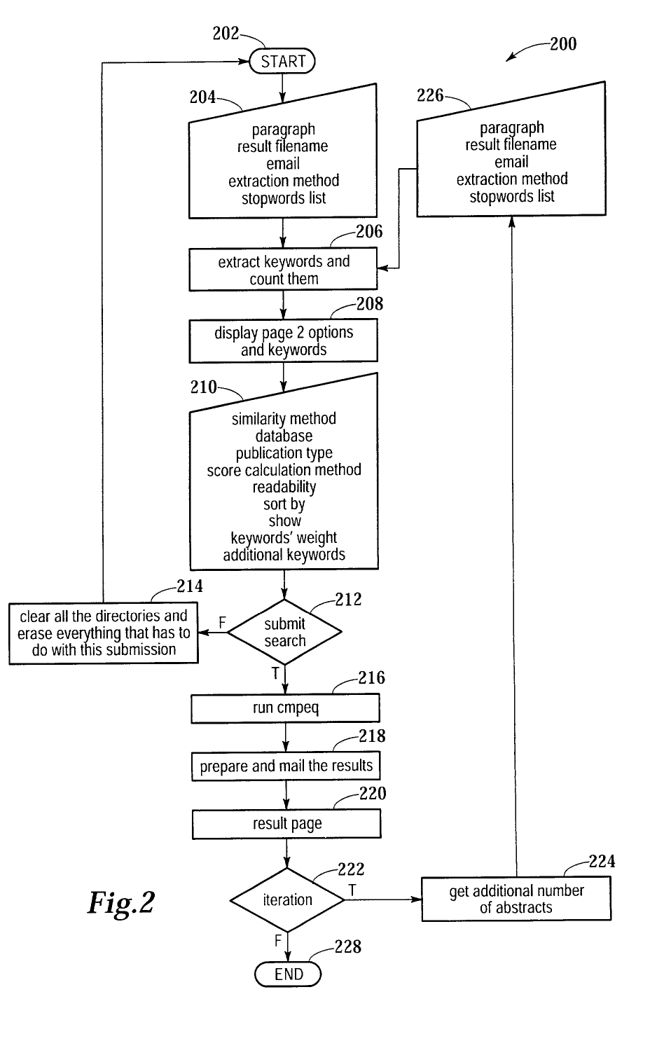

Referring now to FIG. 2, a flow chart illustrating one implementation of the present invention 200 is shown. The present invention starts in block 202 and a user specifies certain operating parameters in block 204. These operating parameters may include a paragraph containing the search terms, a file name where the results are to be stored, an e-mail address for sending notifications, an extraction method to be used and a stop words list. One or more keywords are then extracted from the paragraph and counted in block 206. Various search options and the extracted keywords are displayed to the user in block 208. Thereafter, the user selects the desired search options in block 210. Note that certain default settings may be used so that the user can run the search without reentering the search options each time the process is run. Note that the default settings can be determined by the system or the user or a combination of both. Once all the search options are selected, the user can submit the search. If the search is not submitted or cancelled, as determined in decision block 212, all of the directories are cleared and everything having to do with the cancelled submission is erased in block 214. Processing then returns to block 202 where the process re-starts. The user may be given the option to exit the process at anytime during the processing functions illustrated between blocks 202 and 214.

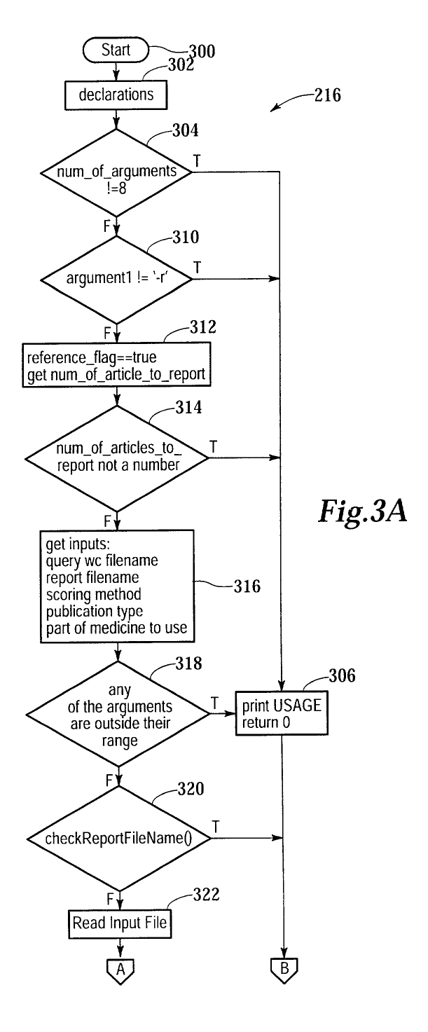

If, however, the search is submitted, as determined in decision block 212, the comparison process is executed in block 216. The comparison process 216 is described in more detail in reference to FIGS. 3A and 3B. After the comparison process 216 is complete, the search results are prepared and e-mailed to the user in block 218. A search results page is also displayed to the user in block 220. If an iterative search was selected, as determined in decision block 222, the process gets an additional number of abstracts in block 224. The operating parameters are retrieved by the system and may be modified by the user in block 226. Thereafter, the process extracts the keywords from the paragraph and counts them in block 206 as before. The process continues from block 206 as described above. If, however, an iterative search was not selected, as determined in decision block 222, the process ends in block 228.

Now referring to FIGS. 3A and 3B, a flow chart illustrating the comparison process 216 of FIG. 2 is shown. The comparison process 216 starts in block 300 and various declarations are made in block 302. If the incorrect number of arguments is received, which in the example is eight, as determined in decision block 304, the system usage is printed and a zero is returned in block 306. The process then ends in block 308. If, however, the correct number of arguments is received, as determined in decision block 304, but the first argument is not set to “-r”, as determined in decision block 310, the system usage is printed and a zero is returned in block 306. The process then ends in block 308. If, however, the first argument is set to “-r”, as determined in decision block 310, the reference flag is set to true and the number of articles to report is retrieved in block 312. If the number of articles to report is not a number, as determined in decision block 314, the system usage is printed and a zero is returned in block 306. The process then ends in block 308. If, however, the number of articles to report is a number, as determined in decision block 314, the inputs, query wc filename, report filename, scoring method, publication type and part of the database, such as Medline, to be used are retrieved in block 316. If any of these retrieved arguments are outside of their acceptable ranges, as determined in decision block 318, the system usage is printed and a zero is returned in block 306. The process then ends in block 308.

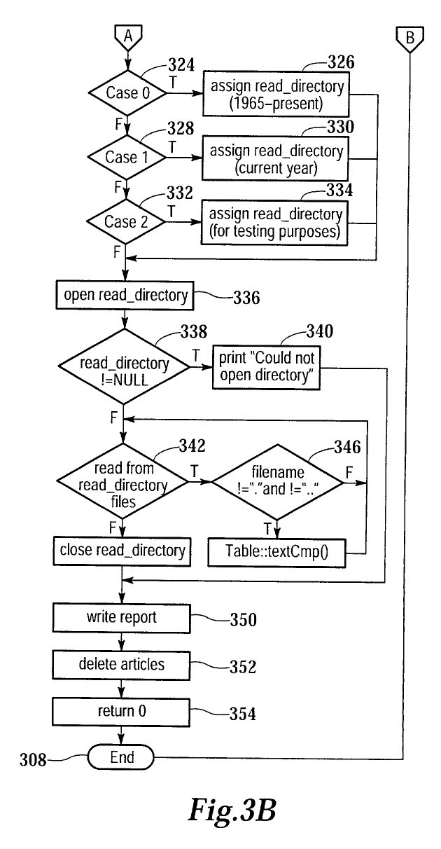

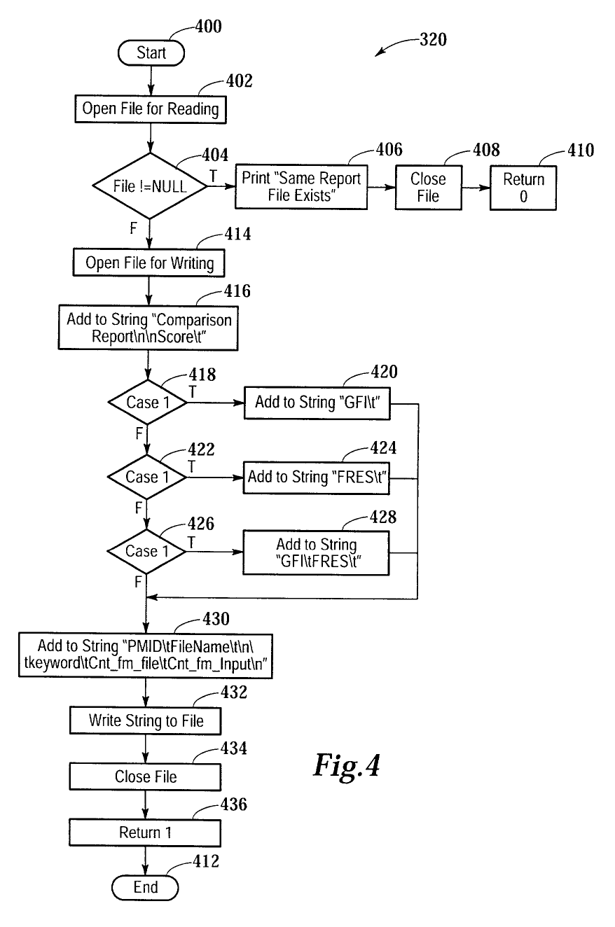

If, however, all of the retrieved arguments are inside of their acceptable ranges, as determined in decision block 318, and the check report file name process is true, as determined in decision block 320, the process ends in block 308. The check report file name process 320 is described in more detail in reference to FIG. 4. If, however, the check file name process is false, as determined in decision block 320, the input file is read in block 322. The read input file process 322 is described in more detail in reference to FIG. 5. If a search of documents from 1965 to present has been selected, as determined in decision block 324, the read directory is assigned to 1965 to present in block 326. If, however, a search of documents from 1965 to present was not selected, as determined in decision block 324, but a search of documents from the current year was selected, as determined in decision block 328, the read directory is assigned to the current year in block 330. If, however, a search of documents from the current year was not selected, as determined in decision block 328, but a documents from the test database was selected, as determined in decision block 332, the read directory is assigned to the test database in block 334. If, however, a search of documents from the test database was not selected, as determined in decision block 332, a default database will be assigned the read directory. Once the read directory is assigned in blocks 326, 330 or 334, or the default is used, the read directory is opened in block 336.

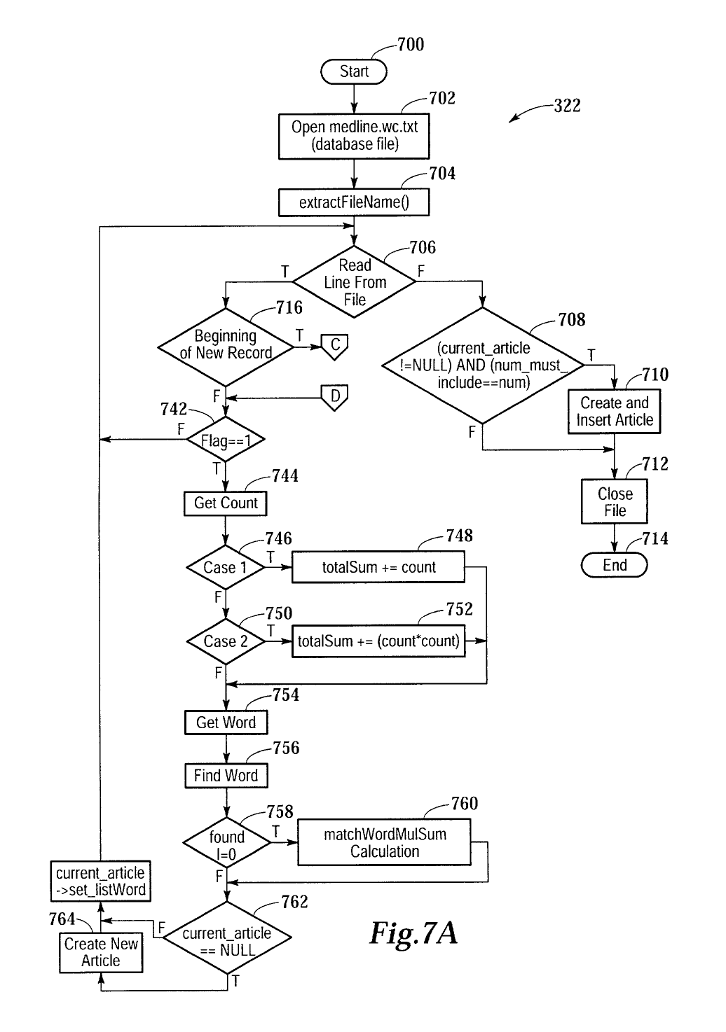

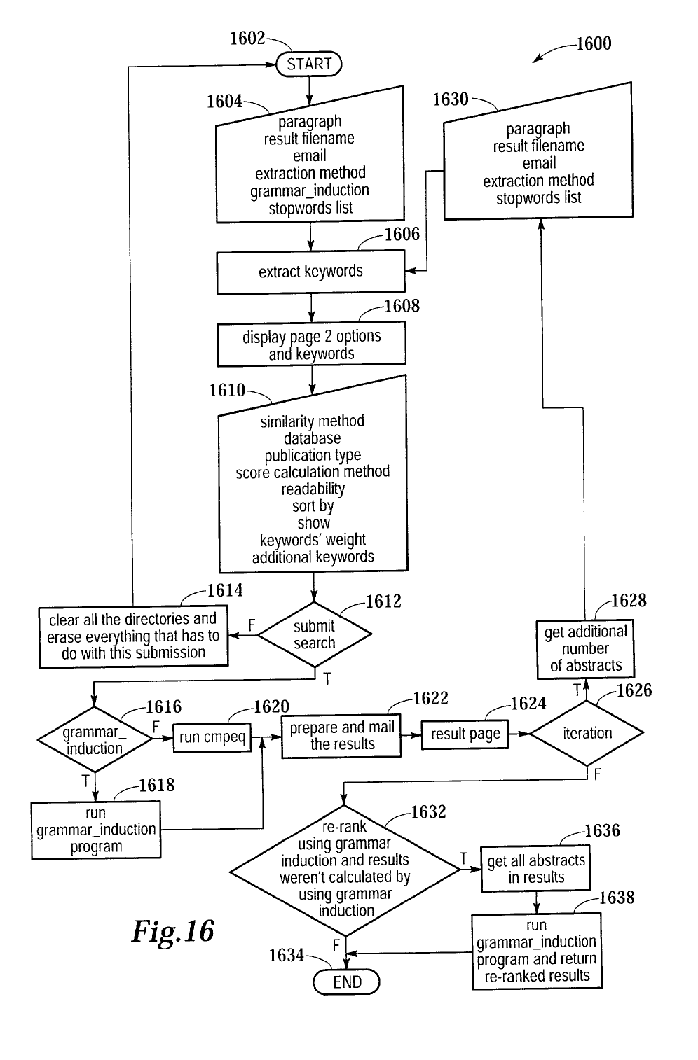

If the read directory is not successfully opened, as determined in decision block 338, an error message indicating that the directory could not be opened is written in the result file in block 340. If the read directory is successfully opened, as determined in decision block 338, and the system is unable to read from the read directory files, as determined in decision block 342, the read directory is closed in block 344. If the system was able to read from the read directory files, as determined in decision block 342, and the file name is valid, as determined in decision block 346, the text comparison process is executed in block 348. The text comparison process 348 is described in more detail in reference to FIG. 7. Thereafter, the process loops back to block 342. If, however, the file name is not valid, as determined in decision block 346, the process loops back to block 342. Once the error message is written in block 340 or the read directory is closed in block 344, the report is written in block 350. The write report process 350 is described in more detail in reference to FIGS. 15A and 15B. Thereafter, the articles are deleted in block 352, a zero is returned in block 354 and the process ends in block 308.

Referring now to FIG. 4, a flow chart illustrating the check report file name process 320 of FIGS. 3A and 3B is shown. The check report file name process 320 begins starts in block 400 and the file is opened for reading in block 402. If the file already exists, as determined in decision block 404, an error message is written in block 406 indicating that the report file already exists, the file is closed in block 408, a zero is returned in block 410 and the process ends in block 412. If, however, the file does not already exist, as determined in decision block 404, the file is opened for writing in block 414 and “Comparison Report\n\nScore\t” is added to a text string in block 416. If the Gunning Fog Index of readability was selected by the user, as determined in decision block 418, “GFI\t” is added to the string in block 420. If, however, the Gunning Fog Index of readability was not selected by the user, as determined in decision block 418, but the Flesch Readability Score was selected, as determined in decision block 422, “FRES\t” is added to the string in block 424. If, however, the Flesch Readability Score was not selected by the user, as determined in decision block 422, but both the Gunning Fog Index of readability and the Flesch Readability Score were selected, as determined in decision block 426, “GFI\tFRES\t” is added to the string in block 428. If, however, both the Gunning Fog Index of readability and the Flesch Readability Score were not selected, as determined in decision block 426, no readability method was specified. After the additional information has been added to the string in blocks 420, 424 or 426, or no readability method was specified, “PMID\tFileName\t\n\tkeyword\tCnt_fm_file\tCnt_fm_input\n” is added to the string in block 430. The string is then written to the file in block 432, the file is closed in block 434, a one is returned in block 436 and the process ends in block 412.

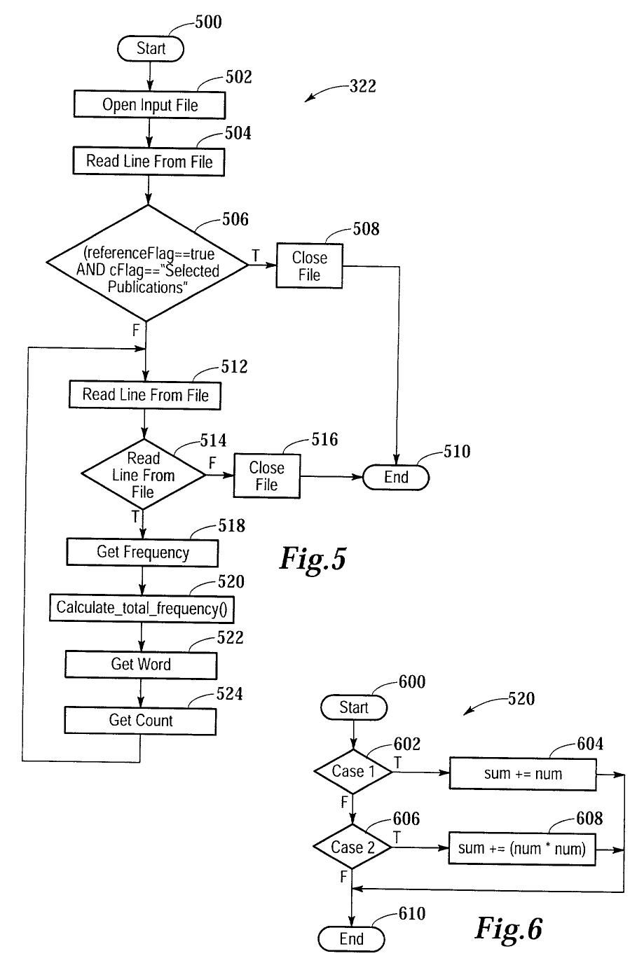

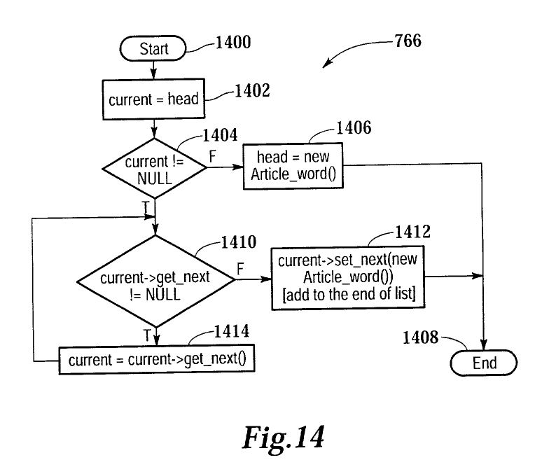

Now referring to FIG. 5, a flow chart illustrating the read input file process 322 of FIGS. 3A and 3B is shown. The read input file process 322 starts in block 500, the input file is opened in block 502 and a line is read from the file in block 504. If the reference flag is true and the flag line is equal to selected publications, as determined in decision block 506, the file is closed in block 508 and the process ends in block 510. If, however, the reference flag is not true or the flag line is not equal to selected publications, as determined in decision block 506, a line is read from the file in block 512. If the line is not successfully read, as determined in decision block 514, the file is closed in block 516 and the process ends in block 510. If the line is successfully read, as determined in decision block 514, a frequency is obtained in block 518 and the total frequency is calculated in block 520. The total frequency calculation process 520 is described in more detail in reference to FIG. 6. Thereafter, the word is obtained in block 522, the count is obtained in block 524 and the process loops back to block 512 where another line is read from the file. The get word or insert word process 522 is further described in reference to FIG. 13.

Referring now to FIG. 6, a flow chart illustrating the calculate total frequency process 520 of FIG. 5 is shown. The calculate total frequency process 520 starts in block 600. If total frequency calculation method one is selected, as determined in decision block 602, the total frequency is calculated using the equation sum+=num in block 604 where num equals the word count, and the process ends in block 610. If total frequency calculation method one is not selected, as determined in decision block 602, and if total frequency calculation method two is selected, as determined in decision block 606, the total frequency is calculated using the equation sum+=(num*num) where num equals the work count in block 608, and the process ends in block 610. If total frequency calculation method two is not selected, as determined in decision block 606, the process ends in block 610.

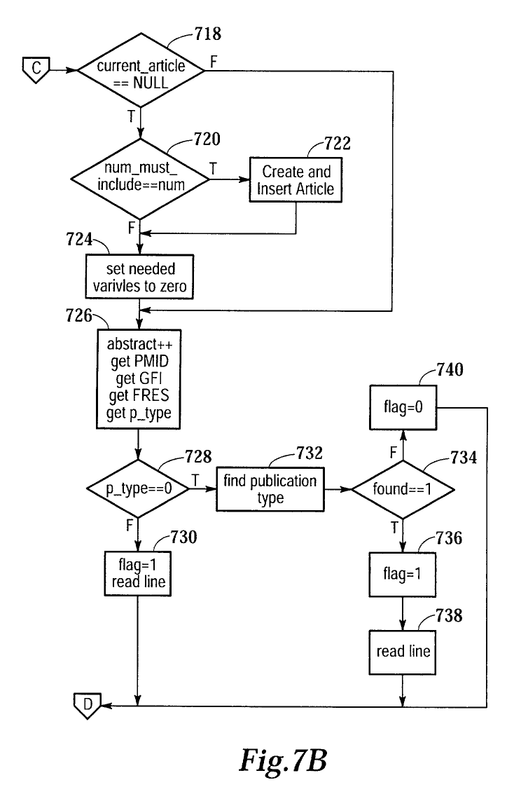

Now referring to FIG. 7, a flow chart illustrating the text comparison process 348 of FIGS. 3A and 3B is shown. The text comparison process 348 starts in block 700, the database file, which in this example is medline.wc.txt, is opened in block 702 and the file name is extracted in block 704. If the line from the file is not successfully read, as determined in decision block 706, and if the current article is not NULL and num must include is equal to num, as determined in decision block 708, the create and insert article process is executed in block 710. The create and insert article process 710 is described in more detail in reference to FIG. 8. Thereafter and if the current article is NULL or num must include is not equal to num, as determined in decision block 708, the file is closed in block 712 and the process ends in block 714.

If, however, the line from the file is successfully read, as determined in decision block 706, and if the current article is not NULL, as determined in decision block 718, and if the num must include is not equal to num, as determined in decision block 720, the needed variables are set to zero in block 724. If, however, the num must include is equal to num, as determined in decision block 720, the create and insert article process is executed in block 722 and the needed variables are set to zero in block 724. The create and insert article process 722 is described in more detail in reference to FIG. 8. If, however, the current article is NULL, as determined in decision block 718, or after the completion of block 724, the abstract is incremented and the PMID, GFI, FRES and p_type values are obtained in block 726. If p_type equals zero, as determined in decision block 728, the flag is set to one and a line is read from the file in block 730. If, however, p_type does not equal zero, as determined in decision block 728, the publication type is obtained in block 732. If the publication type is found, as determined in decision block 734, the flag is set to one and a line is read from the file in block 738. If, however, the publication type is not found, as determined in decision block 734, the flag is set to zero in block 740. If this is not the beginning of a new record, as determined in decision block 716, or the functions of blocks 730, 738 or 740 are completed, the process checks the value of the flag in decision block 742.

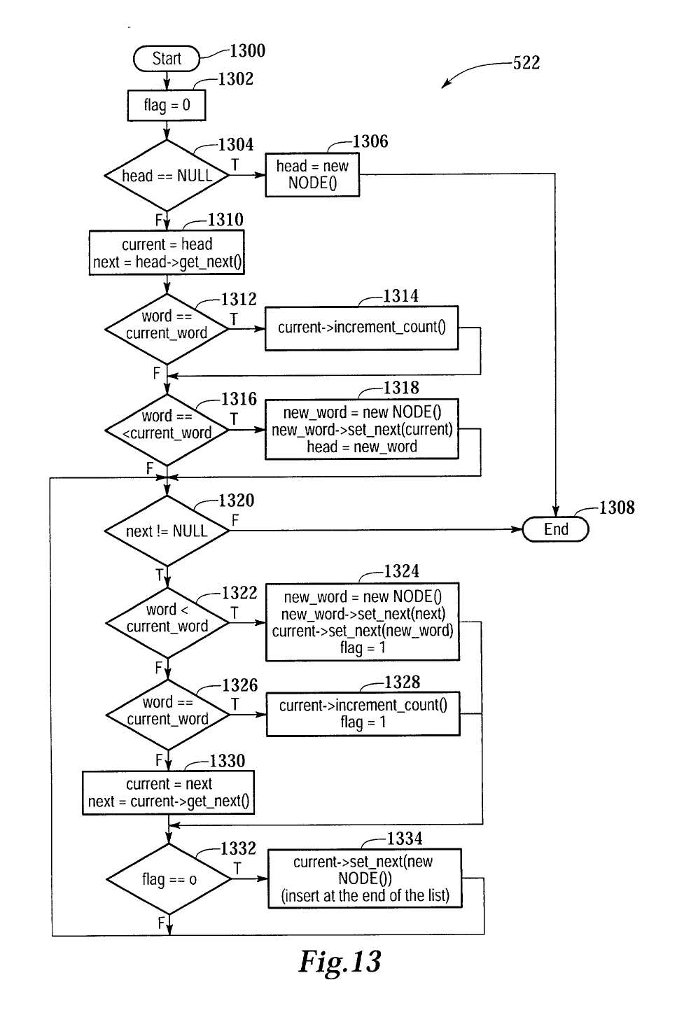

If the flag is not equal to one, as determined in decision block 742, the process loops back to decision block 706. If, however, the flag is equal to one, as determined in decision block 742, the count is obtained in block 744. If frequency calculation method one is selected, as determined in decision block 746, total sum_=count is executed in block 748. If, however, frequency calculation method one is not selected, as determined in decision block 746, and frequency calculation method two is selected, as determined in decision block 750, total sum_=count*count is executed in block 752. If, however, frequency calculation method two is not selected, as determined in decision block 750, or the calculations of blocks 748 or 752 are complete, the word is obtained in block 754 and the find word process is executed in block 756. The find word process 756 is described in more detail in reference to FIG. 12. If the word is found, as determined in decision block 758, a match word multiplication sum is calculated in block 760. The match word multiplication sum is calculated each time a word is found in both the query and the file abstract. The calculation sums up the products of the word's count in the query and the word's count in the abstract. Thereafter, or if the word is not found, as determined in decision block 758, and the current article equals NULL, as determined in decision block 762, a new article is created in block 764. If, however, the current article does not equal NULL, as determined in decision block 762, the set word list process is executed in block 766. The set word list process 766 is described in more detail in reference to FIG. 8. Thereafter, the process loops back to check whether a line was successfully read from the file in decision block 706.

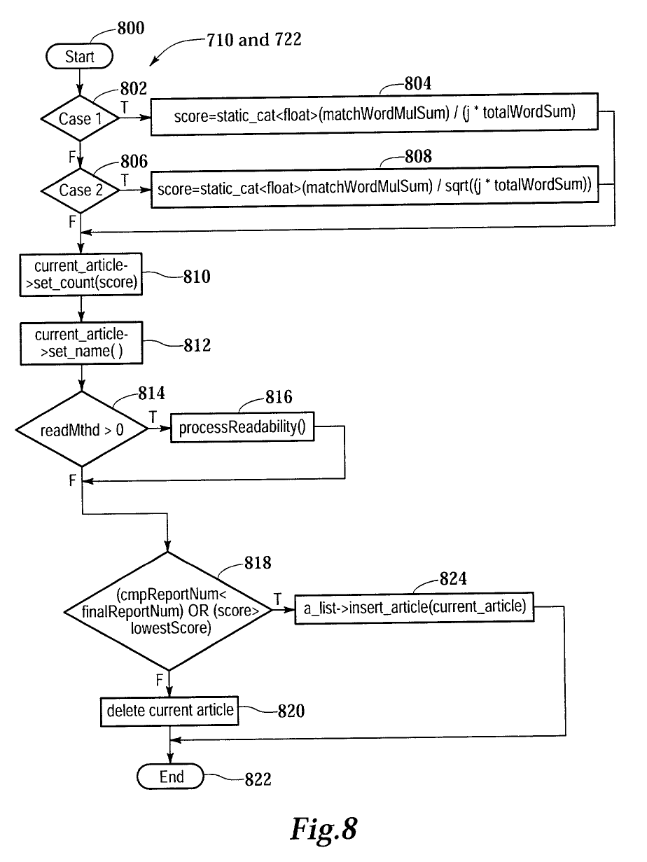

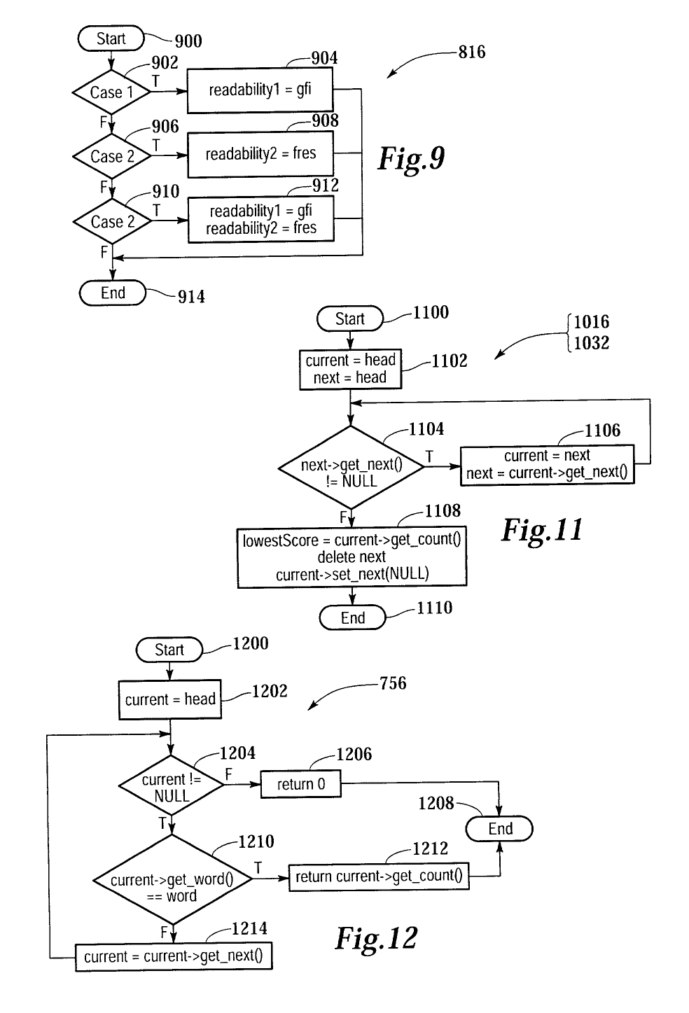

Referring now to FIG. 8, a flow chart illustrating the create and insert article process 710 and 722 of FIG. 7 is shown. The create and insert article process 710 and 722 starts in block 800. If scoring method one is selected, as determined in decision block 802, the score of the abstract is calculated by dividing the match word multiplier sum by the product of j and the total word sum in block 804. If, however, scoring method one is not selected, as determined in decision block 802, and scoring method two is selected, as determined in decision block 806, the score of the abstract is calculated by dividing the match word multiplier sum by the square root of the product of j and the total word sum in block 808. After the completion of blocks 804 or 808 or if scoring method two is not selected, as determined in decision block 806, the count of the current article is set to the score in block 810 and the name of the current article is set in block 812. If a readability option was selected, as determined in decision block 814, the process readability process is executed in block 816. The process readability process 816 is described in more detail in reference to FIG. 9. Thereafter, or if a readability option was not selected, as determined in decision block 814, if the current report number is less than the final report number or the score is greater than the lowest score, as determined in decision block 818, the article is inserted in block 824. The insert article process 824 is described in more detail in reference to FIG. 10. If, however, the current report number is not less than the final report number and the score is not greater than the lowest score, as determined in decision block 818, the current article is deleted in block 820. After completion of the functions of blocks 820 and 824, the process ends in block 822.

Now referring to FIG. 9, a flow chart illustrating the process readability process 816 of FIG. 8 is shown. If the Gunning Fog Index of readability was selected by the user, as determined in decision block 902, the Gunning Fog Index is obtained in block 904. If, however, the Gunning Fog Index of readability was not selected by the user, as determined in decision block 902, but the Flesch Readability Score was selected, as determined in decision block 906, the Flesch Readability Score is obtained in block 908. If, however, the Flesch Readability Score was not selected by the user, as determined in decision block 906, but both the Gunning Fog Index of readability and the Flesch Readability Score were selected, as determined in decision block 910, both the Gunning Fog Index and the Flesch Readability Score are obtained in block 912. If, however, both the Gunning Fog Index of readability and the Flesch Readability Score were not selected, as determined in decision block 910, no readability method was specified and the process ends in block 914. The process also ends after the readability values have been obtained in blocks 904, 908 or 912.

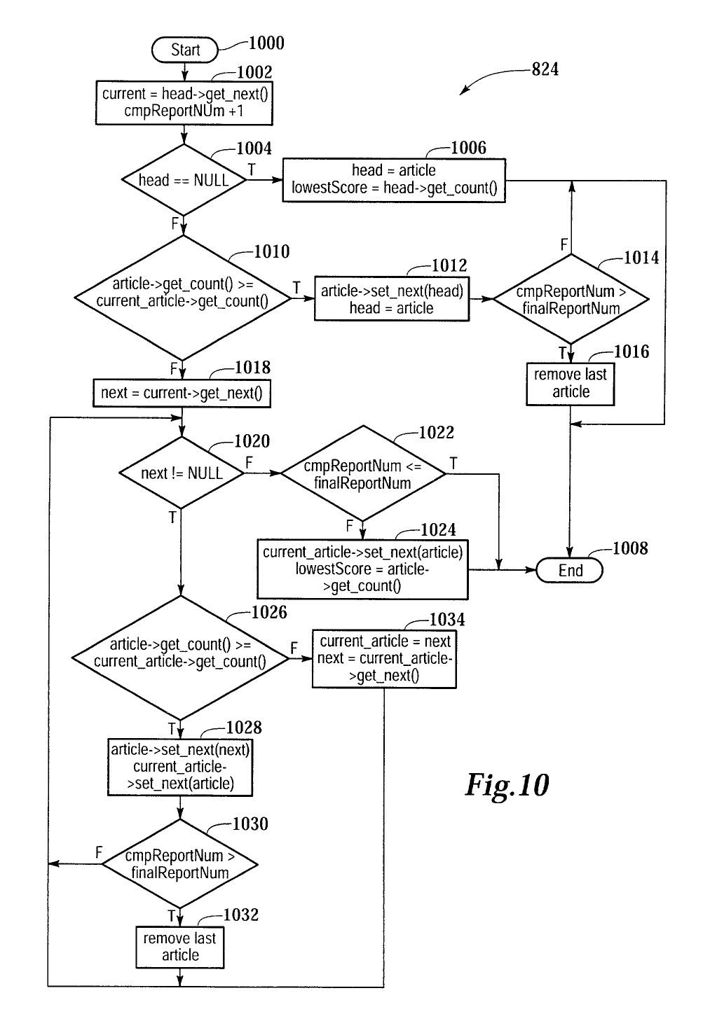

Referring now to FIG. 10, a flow chart illustrating the insert article process 824 of FIG. 8 is shown. The insert article process 824 starts in block 1000 and current article is set to the next article and the number of reports is incremented in block 1002. If the head equals NULL, as determined in decision block 1004, the head is set equal to the article and the lowest score is set to the count in block 1006 and the process ends in block 1008. If, however, the head does not equals NULL, as determined in decision block 1004, and the article count is greater than or equal to the count of the current article, as determined in decision block 1010, the article is set to the next head and the head is set equal to the article in block 1012. If the number of reports is less that the number of final reports, as determined in decision block 1014, the remove last article process is executed in block 1016. The remove last article process 1016 is described in more detail in reference to FIG. 11. Thereafter, or if, however, the number of reports is greater than or equal to the number of final reports, as determined in decision block 1014, the process ends in block 1008. If, however, the article count is less than the count of the current article, as determined in decision block 1010, next is set equal to the current in block 1018.

If the next equals NULL, as determined in decision block 1020, and the number of reports is less than or equal to the number of final reports, as determined in decision block 1022, the current article is set to the next article and the lowest score is set to the count of the article in block 1024. Thereafter, or if the number of reports is greater than the number of final reports, as determined in decision block 1022, the process ends in block 1008. If, however, the next is not equal to NULL, as determined in decision block 1020, and the count of the article is greater than or equal to the current article count, as determined in decision block 1026, the article is set to the next article and the current article is set to the next article in block 1028. If the number of reports is greater than the number of final reports, as determined in decision block 1030, the last article is removed in block 1032. The remove last article process 1032 is described in more detail in reference to FIG. 11. If, however, the count of the article is less than the current article count, as determined in decision block 1026, the current article is set equal to next and next is set equal to the next current article in block 1034. Thereafter, or after the last article is removed in block 1032 or if the number of reports is less than or equal to the number of final reports, as determined in decision block 1030, the process loops back to determine whether the next is not equal to NULL, as determined in decision block 1020.

Now referring to FIG. 11, a flow chart illustrating the remove last article process 1016 and 1032 of FIG. 10 is shown. The remove last article process 1016 and 1032 starts in block 1100 and the current is set to the head and the next is set to the head in block 1102. If the next is not equal to NULL, as determined in decision block 1104, the current is set equal to next and next is set equal to the next current in block 1106. Thereafter, the process loops back to decision block 1104. If, however, the next is equal to NULL, as determined in decision block 1104, the lowest score is set to the current count, the next is deleted and the current is set to NULL in block 1108, and the process end in block 1110.

Referring now to FIG. 12, a flow chart illustrating the find word process 756 of FIG. 7 is shown. The find word process 756 starts in block 1200 and the current is set equal to head in block 1202. If the current is equal to NULL, as determined in decision block 1204, a zero is returned in block 1206 and the process ends in block 1208. If, however, the current is not equal to NULL, as determined in decision block 1204, and the word of the current article is equal to word, as determined in decision block 1210, the count of the current article is returned in block 1212 and the process ends in block 1208. If, however, the word of the current article is not equal to word, as determined in decision block 1210, the current is set equal to the next current in block 1214 and the process loops back to decision block 1204.

Now referring to FIG. 13, a flow chart illustrating the get word or insert word process 522 of FIG. 5 is shown. The insert word process starts in block 1300 and the flag is set to zero in block 1302. If the head is equal to NULL, as determined in decision block 1304, the head is set to new NODE( ) in block 1306 and the process ends in block 1308. If, however, the head is not equal to NULL, as determined in decision block 1304, the current is set equal to head and the next is set equal to the next head in block 1310. If the word is equal to the current word, as determined in decision block 1312, the current count is incremented in block 1314. Thereafter, or if the word is not equal to the current word, as determined in decision block 1312, and the word is less than the current word, as determined in decision block 1316, the new word is set equal to new NODE( ), new word is set to the next current and the head is set to the new word in block 1318. Thereafter, or if the word is greater than or equal to the current word, as determined in decision block 1316, and the next is equal to NULL, as determined in decision block 1320, the process ends in block 1308. If, however, the next is not equal to NULL, as determined in decision block 1320, and the word is less than the current word, as determined in decision block 1322, the new word is set equal to new NODE( ), new word is set to the next, the current is set to the next word and the flag is set to one in block 1324. If, however, the word is greater than or equal to the current word, as determined in decision block 1322, and the word is equal to the current word, as determined in decision block 1326, the current count is incremented and the flag is set to one in block 1328. If, however, the word is not equal to the current word, as determined in decision block 1326, the current is set to next and the next is set to the next current in block 1330. Thereafter, or after the completion of blocks 1324 or 1328, and if the flag is equal to zero, as determined in decision block 1332, the current is set the next new NODE( ) in block 1334. Thereafter, or if the flag is not equal to zero, as determined in decision block 1332, the process loops back to decision block 1320.

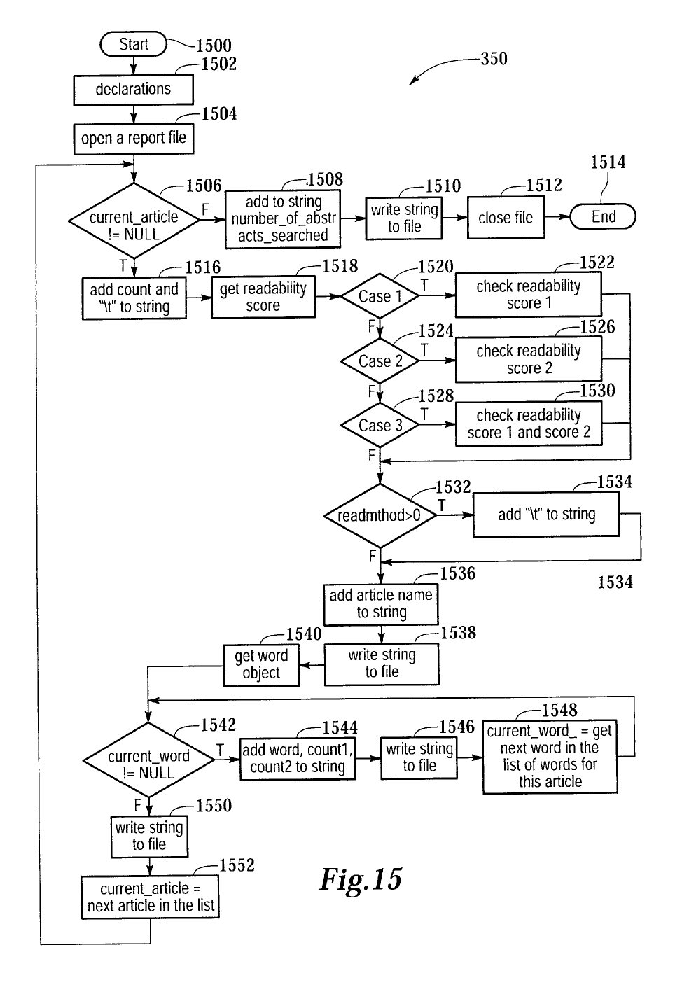

Referring now to FIG. 14, a flow chart illustrating the set word list process 766 of FIG. 7 is shown. The set word list process 766 starts in block 1400 and current is set equal to head in block 1402. If current is equal to NULL, as determined in decision block 1404, head is set to new article word in block 1406 and the process ends in block 1408. If, however, current is not equal to NULL, as determined in decision block 1404, and the next current is equal to NULL, as determined in decision block 1410, current is set to the next new article word in block 1412 and the process ends in block 1408. If, however, the next current is not equal to NULL, as determined in decision block 1410, current is set to the next block 1414 and the process loops back to decision block 1410.

Now referring to FIGS. 15A and 15B, a flow chart illustrating the write report process 350 of FIGS. 3A and 3B is shown. The write report process 350 starts in block 1500, declarations are made in block 1502 and the report file is opened in block 1504. If the current article is NULL, as determined in decision block 1506, the number of abstracts searched is added to the string in block 1508, the string is written to the file in block 1510, the file is closed in block 1512 and the process ends in block 1514. If, however, the current article is not NULL, as determined in decision block 1506, the count and “\t” are added to the string in block 1516 and the readability score is obtained in block 1518. If the Gunning Fog Index of readability was selected by the user, as determined in decision block 1520, the readability score is checked in block 1522. If, however, the Gunning Fog Index of readability was not selected by the user, as determined in decision block 1520, but the Flesch Readability Score was selected, as determined in decision block 1524, the readability score is checked in block 1526. If, however, the Flesch Readability Score was not selected by the user, as determined in decision block 1524, but both the Gunning Fog Index of readability and the Flesch Readability Score were selected, as determined in decision block 1528, both readability scores are checked in block 1530. If, however, both the Gunning Fog Index of readability and the Flesch Readability Score were not selected, as determined in decision block 1528, no readability method was specified.

After the readability scores have been checked in blocks 1522, 1526 or 1530, or no readability method was specified, the article name is added to the string in block 1536. The string is then written to the file in block 1538 and the word object is retrieved in block 1540. If the current word is not equal to NULL, as determined in decision block 1542, the word, count for the query and count for the article are added to the file in block 1544, and the string is written to the file in block 1546. Thereafter, the current word is set equal to the next word in the list of words for this article in block 1548 and the process loops back to decision block 1542. If, however, the current word is equal to NULL, as determined in decision block 1542, the string is written to the file in block 1550 and the current article is set to the next article in the list in block 1552. Thereafter, the process loops back to decision block 1506.

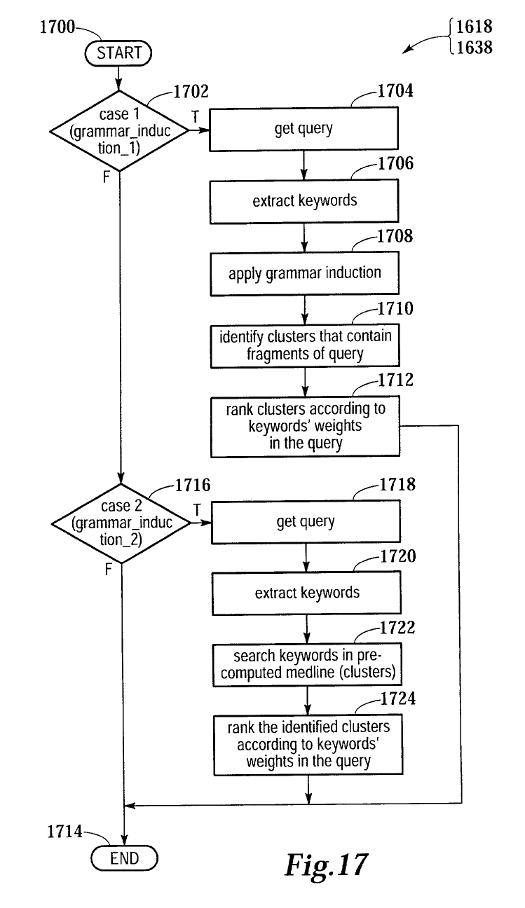

Referring now to FIG. 16, a flow chart illustrating another implementation of the present invention with grammar induction is shown. The present invention 1600 starts in block 1602 and a user specifies certain operating parameters in block 1604. These operating parameters may include a paragraph containing the search terms, a file name where the results are to be stored, an e-mail address for sending notifications, an extraction method to be used, the use of grammar induction and a stop words list. One or more keywords are then extracted from the paragraph and counted in block 1606. Various search options and the extracted keywords are displayed to the user in block 1608. Thereafter, the user selects the desired search options in block 1610. Note that certain default settings may be used so that the user can run the search without reentering the search options each time the process is run. Note that the default settings can be determined by the system or the user or a combination of both. Once all the search options are selected, the user can submit the search. If the search is not submitted or cancelled, as determined in decision block 1612, all of the directories are cleared and everything having to do with the cancelled submission is erased in block 1614. Processing then returns to block 1602 where the process re-starts. The user may be given the option to exit the process at anytime during the processing functions illustrated between blocks 1602 and 1614.

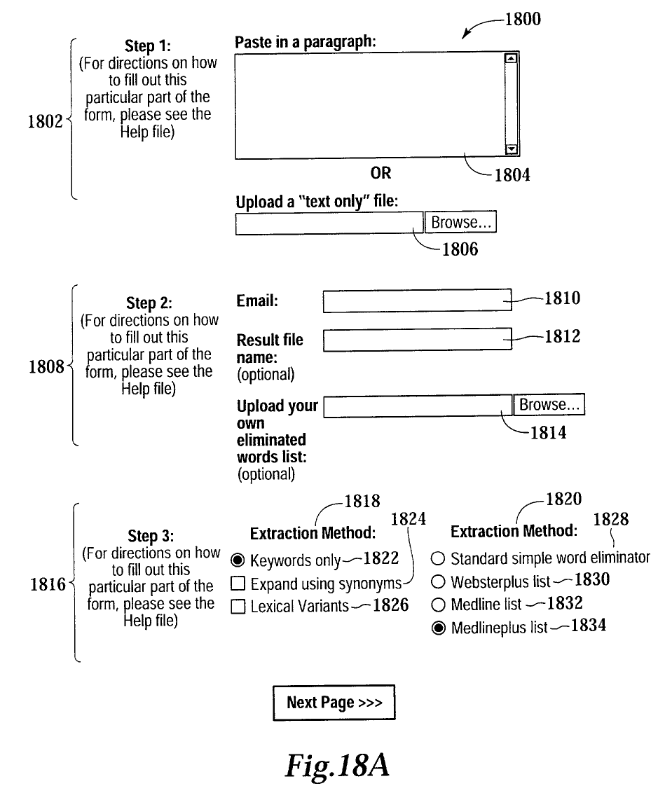

If, however, the search is submitted, as determined in decision block 1612, and grammar induction is not selected, as determined in decision block 1616, the comparison process is executed in block 1620. The comparison process 1620 is described in more detail in reference to FIGS. 3A and 3B. If, however, grammar induction is selected, as determined in decision block 1616, the grammar induction process is executed in block 1618. The grammar induction process 1618 is described in more detail in reference to FIG. 17. After the comparison process 1620 or the grammar induction process 1618 are complete, the search results are prepared and e-mailed to the user in block 1622. A search results page is also displayed to the user in block 1624. If an iterative search was selected, as determined in decision block 1626, the process gets an additional number of abstracts in block 1628. The operating parameters are retrieved by the system and may be modified by the user in block 1630. Thereafter, the process extracts the keywords from the paragraph and counts them in block 1606 as before. The process continues from block 1606 as described above. If, however, an iterative search was not selected, as determined in decision block 1626, and re-ranking of the results using grammar induction is not necessary or the results were calculated using grammar induction, as determined in decision block 1632, the process ends in block 228. If, however, the re-ranking of the results using grammar induction is necessary and the results were not calculated using grammar induction, as determined in decision block 1632, all the abstracts in the results are retrieved in block 1636, the grammar induction process is run and the re-ranked results are returned in block 1638 and the process ends in block 1634. The grammar induction process 1638 is described in more detail in reference to FIG. 17.

Now referring to FIG. 17 is a flow chart illustrating a grammar induction process 1618 and 1638 of FIG. 16 is shown. The grammar induction process 1618 and 1638 starts in block 1700. If the grammar induction mode one is selected, as determined in decision block 1702, the query is retrieved in block 1704, the keywords are extracted in block 1706 and grammar induction is applied in block 1708. Clusters that contain fragments of the query are identified in block 1710, the clusters are ranked according to keyword weights in the query in block 1712 and the process ends in block 1714. If, however, the grammar induction mode one is not selected, as determined in decision block 1702, and grammar induction mode is selected, as determined in decision block 1716, the query is retrieved in block 1718 and the keywords are extracted in block 1720. The keywords are searched in a precomputed database cluster, such as Medline, in block 1722, the identified clusters are ranked according to the keyword weights in the query in block 1724 and the process ends in block 1714.

The similarity between two text fragments can be determined a dynamic programming method wherein the higher the similarity score, the more similar the two text fragments are to one another. This is the basis for the grammar induction described above. The similarity scores can then be used to compute optimal rankings, retrieve the best entry in the database, or refine results retrieved by another method. The source code to compute such a similarity score could be written as follows:

int Matrix::score(Abstract * query, Abstract * abstract)
{

int n = vertical_size;
int m = horizontal_size;
double cost = 0.0;
double score = 0.0;
if (n == 0) return m;
if (m == 0) return n;
for (int i = 0; i < n; i++) matrix[i][0] = 0.0; // vertical
for (int j = 0; j < m ; j++) matrix[0][j] = 0.0; // horizontal
Word * query_current = query->get_head();
for(int i = 1; i < n; i++)
{

Word * abstract_current = abstract->get_head();
for (int j = 1; j < m; j++)
{

if((strcmp(query_current->get_word(),
abstract_current->get_word()) ==

0) && (query_current->get_keyword() == 1 ))
cost = 1;

else if (( strcmp(query_current->get_word(),
abstract_current-

>get_word()) == 0) &&
( query_current->get_keyword() == 0))
cost = 0;

else

cost = 0;

double above = matrix[i−1][j] − 1;
double diagonal = matrix[i−1][j−1] + cost;
double left = matrix[i][j−1] − 1;
double maximum = above;
if (diagonal > maximum) maximum = diagonal;
if (left > maximum) maximum = left;
if (0 > maximum) maximum = 0;
matrix[i][j] = maximum;
if (maximum > score) score = maximum;
abstract_current = abstract_current->get_next();

}
query_current = query_current->get_next();

}
cout << “score: ”<<score<< “\n”;

}

Those skilled in the art will recognize that the functionality of the above scoring function can be written in many different ways.

Example 1—Phrase one is “Melioidosis is an important public health problem in Southeast Asia and Northern Australia”. Phrase two is the same as phrase one. Both phrases have 13 terms and the keywords: Melioidosis, important, public, health, problem, Southeast, Asia, Northern, Australia. Matrix[i][0] and matrix[0][j] are defined to be zero. The similarity score for the comparison of these two identical phrases is 9. The matrix[ ][ ] having phrase one shown vertically and phrase two horizontally would be:

0 0 0 0 0 0 0 0 0 0 0 0 0 0
0 1 0 0 0 0 0 0 0 0 0 0 0 0
0 0 1 0 0 0 0 0 0 0 0 0 0 0
0 0 0 1 0 0 0 0 0 0 0 0 0 0
0 0 0 0 2 1 0 0 0 0 0 0 0 0
0 0 0 0 1 3 2 1 0 0 0 0 0 0
0 0 0 0 0 2 4 3 2 1 0 0 0 0
0 0 0 0 0 1 3 5 4 3 2 1 0 0
0 0 0 0 0 0 2 4 5 4 3 2 1 0
0 0 0 0 0 0 1 3 4 6 5 4 3 2
0 0 0 0 0 0 0 2 3 5 7 6 5 4
0 0 0 0 0 0 0 1 2 4 6 7 6 5
0 0 0 0 0 0 0 0 1 3 5 6 8 7
0 0 0 0 0 0 0 0 0 2 4 5 7 9

Example 2—Phrase one is “Melioidosis is an important public health problem in Southeast Asia and Northern Australia”. Phrase two is “Melioidosis is a public health problem in Southeast Asia and Northern Australia”. Phrase one has 13 terms and the keywords: Melioidosis, important, public, health, problem, Southeast, Asia, Northern, Australia. Phrase two has 12 terms and the keywords: Melioidosis, public, health, problem, Southeast, Asia, Northern, Australia. Matrix[i][0] and matrix[0][j] are defined to be zero. The similarity score for the comparison of these two identical phrases is 7. The matrix[ ][ ] having phrase one shown vertically and phrase two horizontally would be:

0 0 0 0 0 0 0 0 0 0 0 0 0
0 1 0 0 0 0 0 0 0 0 0 0 0
0 0 1 0 0 0 0 0 0 0 0 0 0
0 0 0 1 0 0 0 0 0 0 0 0 0
0 0 0 0 1 0 0 0 0 0 0 0 0
0 0 0 0 1 1 0 0 0 0 0 0 0
0 0 0 0 0 2 1 0 0 0 0 0 0
0 0 0 0 0 1 3 2 1 0 0 0 0
0 0 0 0 0 0 2 3 2 1 0 0 0
0 0 0 0 0 0 1 2 4 3 2 1 0
0 0 0 0 0 0 0 1 3 5 4 3 2
0 0 0 0 0 0 0 0 2 4 5 4 3
0 0 0 0 0 0 0 0 1 3 4 6 5
0 0 0 0 0 0 0 0 0 2 3 5 7

Example 3—Phrase one is “Melioidosis is an important public health problem in Southeast Asia and Northern Australia”. Phrase two is “Melioidosis is a health problem in Southeast Asia and Northern Australia”. Phrase one has 13 terms and the keywords: Melioidosis, important, public, health, problem, Southeast, Asia, Northern, Australia. Phrase two has 11 terms and the keywords: Melioidosis, health, problem, Southeast, Asia, Northern, Australia. Matrix[i][0] and matrix[0][j] are defined to be zero. The similarity score for the comparison of these two identical phrases is 6. The matrix[ ][ ] having phrase one shown vertically and phrase two horizontally would be:

0 0 0 0 0 0 0 0 0 0 0 0
0 1 0 0 0 0 0 0 0 0 0 0
0 0 1 0 0 0 0 0 0 0 0 0
0 0 0 1 0 0 0 0 0 0 0 0
0 0 0 0 1 0 0 0 0 0 0 0
0 0 0 0 0 1 0 0 0 0 0 0
0 0 0 0 1 0 1 0 0 0 0 0
0 0 0 0 0 2 1 1 0 0 0 0
0 0 0 0 0 1 2 1 1 0 0 0
0 0 0 0 0 0 1 3 2 1 0 0
0 0 0 0 0 0 0 2 4 3 2 1
0 0 0 0 0 0 0 1 3 4 3 2
0 0 0 0 0 0 0 0 2 3 5 4
0 0 0 0 0 0 0 0 1 2 4 6

Example 4—Phrase one is “Melioidosis is an important public health problem in Southeast Asia and Northern Australia”. Phrase two is “health Melioidosis Southeast is an public important in Australia Asia and problem Northern”. Both phrases have 13 terms and the keywords: Melioidosis, important, public, health, problem, Southeast, Asia, Northern, Australia. Matrix[i][0] and matrix[0][j] are defined to be zero. Although both phrases have the same terms and keywords, the similarity score for the comparison of these two phrases is 3. The matrix[ ][ ] having phrase one shown vertically and phrase two horizontally would be:

0 0 0 0 0 0 0 0 0 0 0 0 0 0
0 0 1 0 0 0 0 0 0 0 0 0 0 0
0 0 0 1 0 0 0 0 0 0 0 0 0 0
0 0 0 0 1 0 0 0 0 0 0 0 0 0
0 0 0 0 0 1 0 1 0 0 0 0 0 0
0 0 0 0 0 0 2 1 1 0 0 0 0 0
0 1 0 0 0 0 1 2 1 1 0 0 0 0
0 0 1 0 0 0 0 1 2 1 1 0 1 0
0 0 0 1 0 0 0 0 1 2 1 1 0 1
0 0 0 1 1 0 0 0 0 1 2 1 1 0
0 0 0 0 1 1 0 0 0 0 2 2 1 1
0 0 0 0 0 1 1 0 0 0 1 2 2 1
0 0 0 0 0 0 1 1 0 0 0 1 2 3
0 0 0 0 0 0 0 1 1 1 0 0 1 2

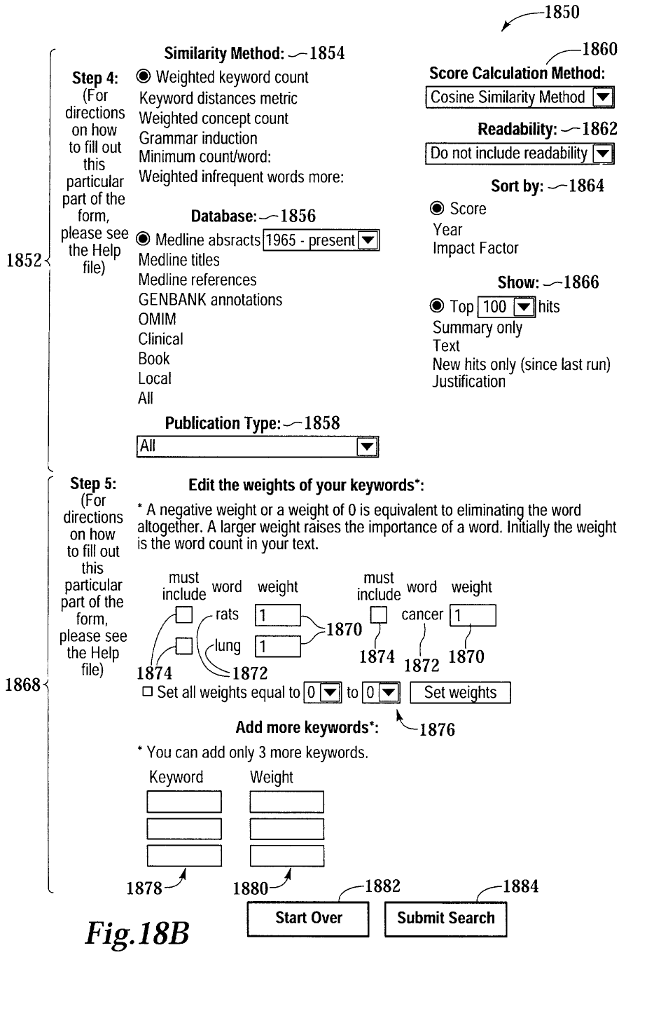

Referring to FIG. 18A, a flow chart illustrating one embodiment of the input/output screen 1800 to obtain the parameters of FIG. 1 block 204 is shown. In step one 1802, the user can either paste a paragraph specifying the search in the space provided 1804 or can upload a file containing the paragraph to be submitted in box 1806.or you can cut and paste your paragraph in the space provided. The file should be text only or other acceptable formats. In this example, Word format will not work.

In step two 1808, the user enters his or her email address in box 1810 and the optional result file name in box 1812. The present invention will use the email address to name the result file unless a result file name is input in box 1812. The user may also enter an optional list of words to be eliminated from the search, also referred to as a stop list, in box 1814. The present invention will use a predefined stop list unless a user list is input in box 1814. The stop list is a compilation of ordinary words such as “a”, “and”, “the”, etc. that are ignored in the similarity search.

In step three 1816, the extraction method 1818 and eliminated words list 1820. The extraction method 1818 can be use keywords only 1822, expand using synonyms 1824 or lexical variants 1826. If use keywords only 1822 is specified, the present invention extracts the keywords from the paragraph 1804 and uses them to search the database. If expand using synonyms 1824 is specified, the database is searched not only for the keywords extracted from the paragraph 1804, but also for the synonyms of those keywords. Lexical variants are used if lexical variants 1826 is specified. The eliminated words list can be standard simple word eliminator 1828, websterplus list 1830, Medline list 1832 or Medlineplus list 1834. The standard simple word elminator 1828 is a compilation of ordinary words such as “a”, “and”, “the”, etc. that are ignored in the similarity search. Websterplus list 1830 is derived from the most used words in the Webster dictionary, and edited for the words likely to be of value in the medical domain. Medline list 1832 is approximately the top 1000 most used words in Medline excluding the words that might be of some value in the search process. The Medlineplus list 1834 is a combination of all the previous lists. The next page button 1836 checks this page for errors and displays the input/output screen 1850 of FIG. 18B.

Now referring to FIG. 18B, a flow chart illustrating one embodiment of the input/output screen 1850 to obtain the parameters of FIG. 1 block 210 is shown. In step four 1852, the similarity method 1854, database 1856, publication type 1858, score calculation method 1860, readability method 1862, sorting criteria 1864 and information shown 1866 are selected. The similarity method 1854 can be selected from a weighted keyword count, keyword distances metric, weighted concept count, grammar induction, minimum count/word or weight infrequent words more. The database 1856 can be selected from Medline abstracts (1965-present or the current year). The publication type 1858 can be selected from All, Addresses, Bibliography, Biography, Classical Article, Clinical Conference, Clinical Trial Clinical Trial—Phase I, Clinical Trial—Phase II, Clinical Trial—Phase III, Clinical Trial—Phase IV, Comment, Congresses, Consensus Development Conference, Consensus Development Conference—NIH, Controlled Clinical Trial, Corrected and Republished Article, Dictionary, Directory, Duplicate Publications, Editorial, Evaluation Studies Festschrift, Government Publications Guideline, Historical Article, Interview Journal Article, Lectures, Legal Cases, Legislation, Letter, Meta-Analysis, Multicenter Study, News, Newspaper Article, Overall, Periodical Index, Practice Guideline, Published Erratum, Randomized Controlled Trial, Retraction of Publication, Retracted Publication Review, Review—Academic, Review—Literature, Review—Multicase, Review of Reported Cases, Review—Tutorial, Scientific Integrity Review, Technical Report, Twin Study, and Validation Studies. The Score Calculation Method 1860 selects the way the abstracts are to be scored, which shows how similar the abstract is to the paragraph 1804. The Score Selection Method 1860 can be selected from the basic normalization method or the cosine similarity method. The Readability method 1862 is the measure of how easy it is to read a given text and is used to predict by the reading ease of an abstract the approximate reading ease of the article itself. The Readability method 1862 can be do not include readability, Gunning Fog Index (“GFI”), Flesch Reading Ease Score (“FRES”), or both GFI and FRES. The results may be sorted 1864 by score, year or impact factor. The information shown 1866 can be the top X number of hits, summary only, text, new hits only (since last run) or justification.

In step five 1868, the weights 1870 of the keywords 1872 can be edited. The higher the weight of a word, the more valuable the word is during the search, the higher will be the score of the abstracts that it was found in. Some of the keywords can be marked as must include 1874. The words that are marked as must include will be the words that definitely appear in the abstracts in the result file. Note that marking too many words may lead to an empty result file because the combination of these words may not appear in any of the abstracts. In addition all pre-weighted words can be set to a different value using the set weights function 1876. Moreover, three more keywords 1878 with weights 1880 can be added to the already existing list of keywords 1872. Clicking on the start over button 1882 will restart the parameter setting process. Clicking on the submit search button 1884 will start the search.

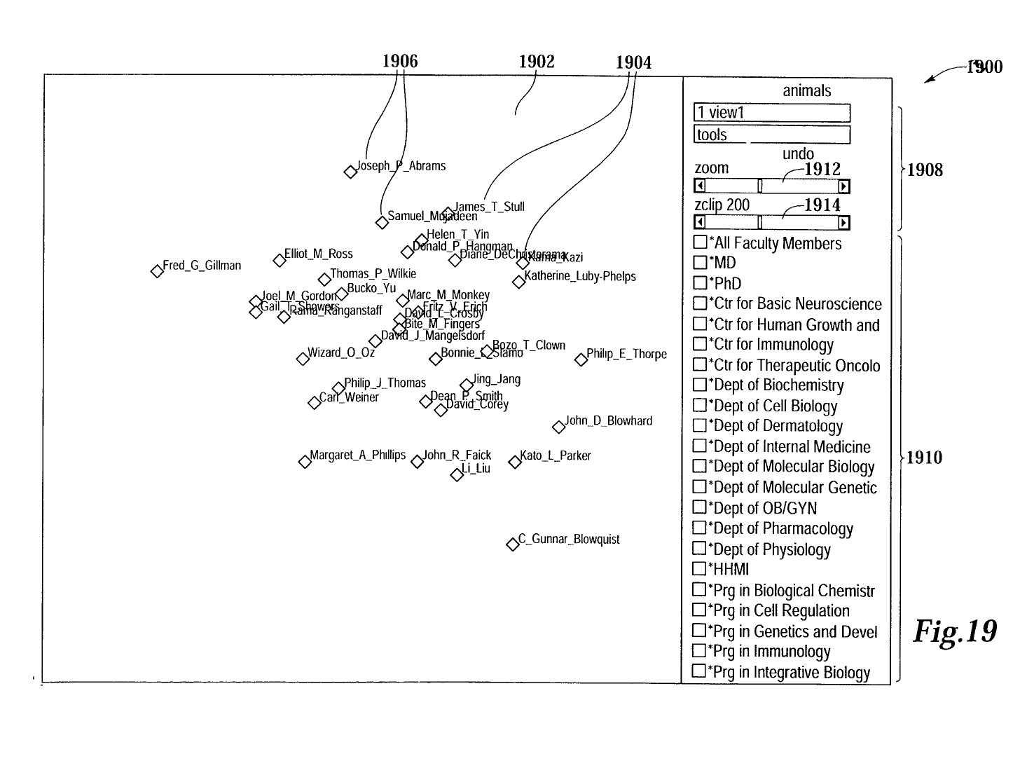

Referring now to FIG. 19, a screen shot of a three dimensional display 1900 of the search results in accordance with one embodiment of the present invention is shown. The display 1902 plots individual search results as spheres 1904 with labels 1906. The orientation of the spheres 1904 can be rotated about any axis by holding down a key of the cursor and moving the cursor in the desired direction. The display aspects 1908 can be changes by adjusting the zoom 1912 or zclip bars 1914. The search results that are displayed can be selected by category using the toggles 1910. For example, members of the Department of Pharmacology and Physiology are currently displayed.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed:

1. A method for retrieving information from computer databases comprising the steps of:
extracting one or more textual elements from one or more queries for comparison with a target database;
assigning a weighting factor to each textual element; and
comparing the textual elements with the target database to identify a first group of selected information units.

2. The method recited in claim 1, wherein the textual elements further comprise keywords.

3. The method recited in claim 1, wherein the textual elements further comprise phrases.

4. The method recited in claim 1, wherein the query comprises a natural language description.

5. The method recited in claim 1, wherein the query comprises a passage from a reference publication.

6. The method recited in claim 1, wherein the comparing comprises application of a similarity algorithm.

7. The method recited in claim 1, wherein the comparing further comprises a concept counting step.

8. The method recited in claim 1, wherein the comparing further comprises application of a keyword distance matrix.

9. The method recited in claim 1, wherein the assignment of the weighting factor is performed manually.

10. The method recited in claim 1, wherein the weighting factor is normalized.

11. The method recited in claim 1, further comprising the step of applying synonym expansion to the query prior to extracting the textual elements.

12. The method recited in claim 1, further comprising the step of applying a lexical variant algorithm to the query prior to extraction of the textual elements.

13. The method recited in claim 1, further comprising the step of applying a grammar induction algorithm to the query prior to extraction of the textual elements.

14. The method recited in claim 1, further comprising the step of applying a stemming algorithm to the query prior to extraction of the textual elements.

15. The method recited in claim 1, wherein the information units comprise complete documents.

16. The method recited in claim 1, wherein the information units comprise less than a complete document.

17. The method recited in claim 1, further comprising the step of repeating the extracting, assigning and comparing steps using the first groups of selected information units as the query to produce a second group of selected information units.

18. The method recited in claim 1, further comprising the step of outputting the first set of information units.

19. The method recited in claim 18, wherein the outputting is in the form of a relational matrix.

20. The method recited in claim 19, wherein the relational matrix is three-dimensional.

21. An information retrieval system comprising:
a processor capable of extracting one or more textual elements from one or more queries for comparison with a target database, assigning a weighting factor to each textual element, and comparing the textual elements with the target database to identify a first group of selected information units; and
one or more databases communicably coupled to the processor.

22. The system recited in claim 21, wherein the textual elements further comprise keywords.

23. The system recited in claim 21, wherein the textual elements further comprise phrases.

24. The system recited in claim 21, wherein the query comprises a natural language description.

25. The system recited in claim 21, wherein the query comprises a passage from a reference publication.

26. The system recited in claim 21, wherein the comparing comprises application of a similarity algorithm.

27. The system recited in claim 21, wherein the comparing further comprises a concept counting step.

28. The system recited in claim 21, wherein the comparing further comprises application of a keyword distance matrix.

29. The system recited in claim 21, wherein the assignment of the weighting factor is performed manually.

30. The system recited in claim 21, wherein the weighting factor is normalized.

31. The system recited in claim 21, further comprising the step of applying synonym expansion to the query prior to extracting the textual elements.

32. The system recited in claim 21, further comprising the step of applying a lexical variant algorithm to the query prior to extraction of the textual elements.

33. The system recited in claim 21, further comprising the step of applying a grammar induction algorithm to the query prior to extraction of the textual elements.

34. The system recited in claim 21, further comprising the step of applying a stemming algorithm to the query prior to extraction of the textual elements.

35. The system recited in claim 21, wherein the information units comprise complete documents.

36. The system recited in claim 21, wherein the information units comprise less than a complete document.

37. The system recited in claim 21, further comprising the step of repeating the extracting, assigning and comparing steps using the first groups of selected information units as the query to produce a second group of selected information units.

38. The system recited in claim 21, further comprising the step of outputting the first set of information units.

39. The system recited in claim 38, wherein the outputting is in the form of a relational matrix.

40. The system recited in claim 39, wherein the relational matrix is represented in three dimensions using dimensionality reduction.
